(19) United States
(12) Patent Application Publication
(10) Pub. No.: US 2018/0024284 A1
(43) Pub. Date: Jan. 25, 2018

(54) Method For Manufacturing Retardation Film By Using Dual-Axial Stretching Process And A Retardation Film

(71) Applicant: Entire Technology Co., Ltd., Taoyuan County (TW)

(72) Inventors: Peng-Yi Huang, Taoyuan County (TW); Shi-Liang Chen, Taoyuan County (TW); Cheng Lun Liao, Taoyuan County (TW)

(73) Assignee: Entire Technology Co., Ltd., Taoyuan County (TW)

(21) Appl. No.: 15/213,614

(22) Filed: Jul. 19, 2016

(51) Int. Cl. G02B 5/30; B29C 55/16

(52) U.S. Cl. CPC G02B 5/3083; B29C 55/16; B29D 11/00788

(57) ABSTRACT

A method for manufacturing a retardation film by using a dual-axial stretching process uses a PMMA to produce a cast film. The cast film is stretched in both a proceeding direction and a width direction simultaneously by 1.0˜5.0 times in both the length and the width. By using a predetermined annealing temperature to co-coordinate shrinking of the film in both directions simultaneously, decrease of the refraction ability caused by the stretching can be controlled. To attain high uniformity of the optical characteristics of the film, the surface temperature of the film during the stretching process is controlled within a predetermined range, then the optical variation thereof is improved, and thus the following optical characteristics are achieved: R0: 0˜3 nm and Rth: −40˜0 nm; wherein R0=α*ΔTe+β*ΔXe+γ*ΔTs+δ*ΔXs+C1 and Rth=a*ΔTe+b*ΔXe+c*ΔTs+d*ΔXs+C2.

### BACKGROUND OF INVENTION

### 1. Field of the Invention

The invention relates to a method for manufacturing a retardation film by using a dual-axial stretching process (also called as a bi-axial stretching process), and more particularly to a method for manufacturing a PMMA (Polymethylmethacrylate) retardation film by using stretching and shrinking processes in the proceeding direction and the width direction simultaneously so as to obtain the PMMA retardation film with substantial high wider optical uniformity.

### 2. Description of the Prior Art

The retardation film is widely applied to an LCD or OLED display panel of the display device, so as to increase the contrast, viewing angle and optical uniformity. A well-known material for the retardation film of the LCD display panel is the TAC (Triacetate cellulose), a cellulose derivative, that has excellent water vapor permeability and thus is good to remove moisture on the polarizer. However, since a stricter rising demand for meeting a high-temperature and high-moisture environment currently in the panel industry, the TAC featured in high water absorption, dimensional stability and surface quality is no more a good choice for the retardation film. Hence, the PMMA gradually replaces the TAC in the marketplace for producing the retardation film.

Since the retardation film is generally asked to present some specific optical characteristics, the ordinary PMMA purchasable in the market can't meet the needs. Thus, a copolymerizing process is usually introduced to modify the PMMA. However, because of production difficulty and cost in synthesizing special polymeric segments, the PMMA does meet a technical barrier of application to the retardation film. Generally speaking, one of crucial topics in manufacturing the retardation film is to control the birefringence of the retardation film. In the art, two resorts are popular to control the birefringence of the retardation film.

1. Alignment birefringence: While at a temperature higher than the glass transition temperature, the molten material would produce an alignment difference which would lead to a difference of the birefringence at the material itself; and

2. Photoelastic birefringence: While the material is stressed to change its volume and so as further to vary the birefringence at all directions, the photoelastic coefficient of the material is usually used as an observation index.

Currently in the marketplace, the normal PMMA usually has a photoelastic coefficient of 6×10⁻¹² Pa⁻¹. While in meeting any stress change, the refractive index of the PMMA would vary. Namely, the birefringence of the PMMA can't be steadily controlled. In the art, a general improvement thereupon is to copolymerize a methyl methacrylate (MMA) with another monomer (such as 3FMA or BzMA) so as to decrease the photoelastic coefficient. However, as described above, such a copolymer usually includes special polymeric segments that are synthesized difficultly and thus costly, and so, in the art, the PMMA is not a popular material for producing the retardation film.

### SUMMARY OF THE INVENTION

Accordingly, it is the primary object of the present invention to provide a method for manufacturing a retardation film by using a dual-axial stretching process that can produce a PMMA retardation film by using stretching and shrinking processes in the proceeding direction and the width direction simultaneously so as to obtain a product film with substantial high wider optical uniformity and without an involvement of copolymerization.

In the present invention, the method for manufacturing a retardation film by using a dual-axial stretching process includes the steps of:

Step (A): providing a cast film;

Step (B): in a preheating process, at a predetermined preheating temperature, preheating the cast film;

Step (C): in a stretching process, at a predetermined stretching temperature, performing simultaneously dual-axial stretching upon the cast film; wherein, in this stretching process, the cast film is stretched by a vertical stretching magnification factor (MD) and a horizontal stretching magnification factor (TD), and both the MD and the TD are within 1.0˜5.0 times;

Step (D): in an annealing process, at a predetermined annealing temperature, annealing the cast film so as to shrink the cast film simultaneously in both a vertical direction and a horizontal direction; and

Step (E): in a cooling process, at a predetermined cooling temperature, cooling the cast film, and then outputting an output retardation film.

In one embodiment of the present invention, the predetermined preheating temperature is within 100˜200° C., and, while in preheating, a preheating wind speed is within 5˜22 m/s; the predetermined stretching temperature is within 120˜200° C., and, while in stretching, a stretching wind speed is within 5˜16 m/s so as to control a temperature of the cast film in the stretching process to be within 120˜170° C.; the predetermined annealing temperature is within 80˜200° C., and, while in annealing, a annealing wind speed is within 5˜22 m/s; the predetermined cooling temperature is within 25˜120° C., and, while in cooling, a cooling wind speed is within 5˜16 m/s; and, in the annealing process, a shrinkage ratio for both the MD and the TD of the cast film is within 0˜18%.

In one embodiment of the present invention, the predetermined stretching temperature (Text), the MD, the TD and the predetermined annealing temperature (Tshrink) fulfill mathematical criteria as follows:

R0=α*ΔTe+β*ΔXe+γ*ΔTs+δ*ΔXs+C1;

Wherein: R0 R0 is an in-plane retardation value of the output retardation film and is within 0˜3 nm; ΔTe is a temperature difference value in the stretching process, and ΔTe=Text−Tg; ΔXe is a stretching magnification factor difference value in the stretching process, and ΔXe=MD−TD; ΔTs is a temperature difference value in the annealing process, and ΔTs=Tshrink−Tg; ΔXs is a shrinkage ratio value of the cast film in the annealing process, and ΔXs=[(1−MDshrink)*(1−TDshrink)−1], wherein the MDshrink is a shrinkage ration of the cast film in the vertical direction in the annealing process, wherein the TDshrink is a shrinkage ration of the cast film in the horizontal direction in the annealing process; and α, β, γ, δ and C1 are all machine parameters, and Tg is a material parameter. Also, according to different processing machines or different raw materials, the corresponding parameter values are different. Preferably, α=−0.0879, β=−6.24, γ=0.011, δ=−12.8, Tg=118 and C1=2.19.

In one embodiment of the present invention, the predetermined stretching temperature (Text), the MD, the TD, and the predetermined annealing temperature (Tshrink) fulfill mathematical criteria as follows:

Rth=a*ΔTe+b*ΔXe+c*ΔTs+d*ΔXs+C2;

wherein: Rth is an in-depth retardation value of the output retardation film and is within −40˜0 nm; ΔTe is a temperature difference value in the stretching process, and ΔTe=Text−Tg; ΔXe is a stretching magnification factor difference value in the stretching process, and ΔXe=MD−TD; ΔTs is a temperature difference value in the annealing process, and ΔTs=Tshrink−Tg; ΔXs is a shrinkage ratio value of the cast film in the annealing process, and ΔXs=[(1−MDshrink)*(1−TDshrink)−1], wherein the MDshrink is a shrinkage ration of the cast film in the vertical direction in the annealing process, wherein the TDshrink is a shrinkage ration of the cast film in the horizontal direction in the annealing process; and a, b, c, d and C2 are all machine parameters, and Tg is a material parameter. Also, according to different processing machines or different raw materials, the corresponding parameter values are different. Preferably, a=0.958, b=2.5, c=0.321, d=12.1, Tg=118 and C2=−39.4.

In one embodiment of the present invention, the cast film is made of a PMMA having a thickness within 250˜1200 μm and a width within 500˜980 μm.

In one embodiment of the present invention, an in-plane retardation value R0 of the output retardation film is within 0˜3 nm, an in-depth retardation value Rth of the output retardation film is within −40˜0 nm, a refractive index Nx of the cast film in an in-plane slow axis direction is within 1.499900˜1.499995, a refractive index Ny of the cast film in an in-plane fast axis direction is within 1.499900˜1.499955, a refractive index Nz of the cast film in a thickness direction is within 1.500001˜1.500045, and a thickness of the output retardation film is within 38˜250 μm.

Another object of the present invention is to provide a retardation film manufactured by using a dual-axial stretching process, wherein an in-plane retardation value R0 of the output retardation film is within 0˜3 nm, an in-depth retardation value Rth of the output retardation film is within −40˜0 nm, a refractive index Nx of the cast film in an in-plane slow axis direction is within 1.499900˜1.499995, a refractive index Ny of the cast film in an in-plane fast axis direction is within 1.499900˜1.499955, a refractive index Nz of the cast film in a thickness direction is within 1.500001˜1.500045, and a thickness of the output retardation film is within 38˜250 μm.

All these objects are achieved by the method for manufacturing a retardation film by using a dual-axial stretching process and the retardation film described below.

### BRIEF DESCRIPTION OF THE DRAWINGS

The present invention will now be specified with reference to its preferred embodiment illustrated in the drawings, in which:

FIG. 1 is a flowchart of a preferred embodiment of the method for manufacturing a retardation film by using a dual-axial stretching process in accordance with the present invention;

FIG. 2 is a schematic view of a preferred embodiment of a die casting machine applicable to the method for manufacturing a retardation film by using a dual-axial stretching process of FIG. 1; and

FIG. 3 is a schematic view of a preferred embodiment of a simultaneous dual-axial stretching machine applicable to the method for manufacturing a retardation film by using a dual-axial stretching process of FIG. 1.

### DESCRIPTION OF THE PREFERRED EMBODIMENT

The invention disclosed herein is directed to a method for manufacturing a retardation film by using a dual-axial stretching process and a retardation film. In the following description, numerous details are set forth in order to provide a thorough understanding of the present invention. It will be appreciated by one skilled in the art that variations of these specific details are possible while still achieving the results of the present invention. In other instance, well-known ingredients are not described in detail in order not to unnecessarily obscure the present invention.

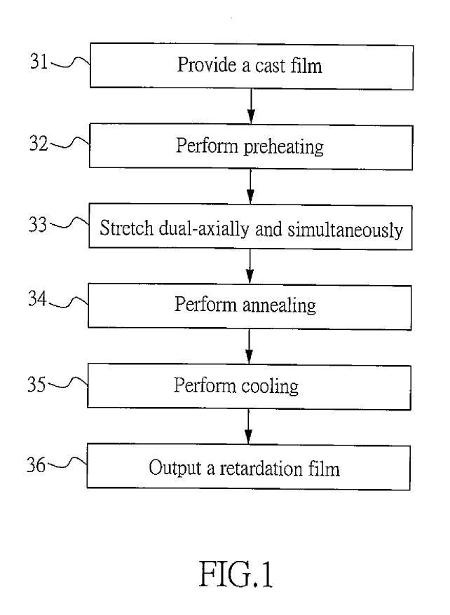

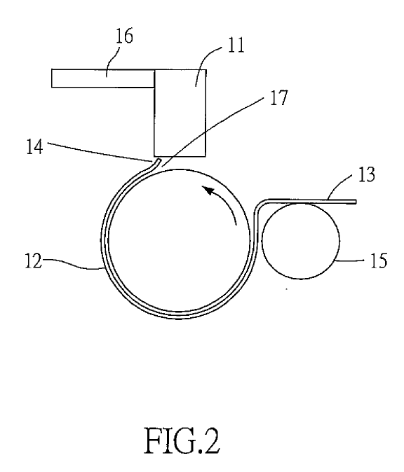

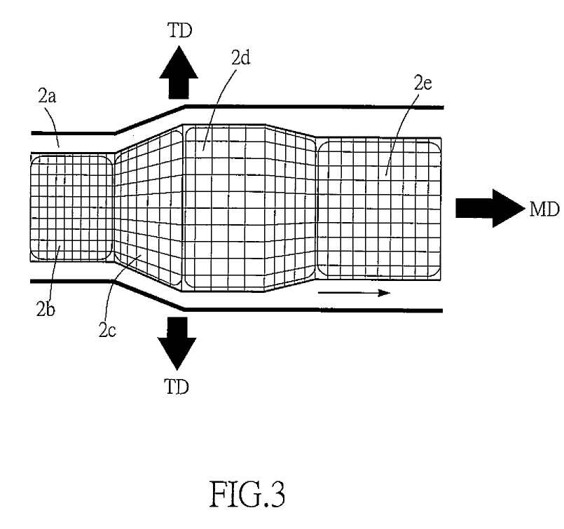

Refer now to FIG. 1, FIG. 2 and FIG. 3; in which FIG. 1 is a flowchart of a preferred embodiment of the method for manufacturing a retardation film by using a dual-axial stretching process in accordance with the present invention, FIG. 2 is a schematic view of a preferred embodiment of a die casting machine applicable to the method for manufacturing a retardation film by using a dual-axial stretching process of FIG. 1, and FIG. 3 is a schematic view of a preferred embodiment of a simultaneous dual-axial stretching machine applicable to the method for manufacturing a retardation film by using a dual-axial stretching process of FIG. 1. As shown in FIG. 1, the method for manufacturing a retardation film by using a dual-axial stretching process in accordance with the present invention includes the following steps.

Step 31: Provide a cast film. Referring to FIG. 2, this die casting machine is used to die-cast a PMMA raw material into a cast film for the following steps of the present embodiment. In this embodiment, the cast film made of the PMMA has a thickness ranged between 250 μm and 1200 μm and a width ranged between 500 μm and 980 μm. The photoelastic coefficient of the cast film is 6×10⁻¹² Pa⁻¹ generally. Details of Step 31 would be elucidated later with FIG. 2.

Step 32: Perform preheating. In a preheating process, at a predetermined preheating temperature, the cast film is preheated. In this embodiment, the predetermined preheating temperature is ranged between 100° C. and 200° C., a preheating wind speed for the preheating process is ranged between 5 m/s and 22 m/s. Namely, in this preheating process, a 100° C.˜200° C. hot wind with a 5 m/s˜22 m/s preheating wind speed is provided to the cast film. Preferably, the predetermined preheating temperature is ranged between 145° C. and 155° C.

Step 33: Stretch dual-axially and simultaneously. In a stretching process, at a predetermined stretching temperature, simultaneous dual-axial stretching is applied to the cast film. In the stretching process, the cast film is stretched to have both a vertical stretching magnification factor (MD) and a horizontal stretching magnification factor (TD) to be ranged from 1.0 to 5.0 times. In this embodiment, the predetermined stretching temperature is ranged between 120° C. and 200° C., and a stretching wind speed is ranged between 5 m/s and 16 m/s. Namely, in this stretching process, a 120° C.˜200° C. hot wind with a 5 m/s˜16 m/s heating wind speed is provided to the cast film, such that a film temperature of the cast film (i.e. the temperature of the cast film itself) during the stretching process can be controlled within 120˜170° C. Preferably, the predetermined stretching temperature is ranged between 130° C. and 150° C.

Step 34: Perform annealing. In an annealing process, at a predetermined annealing temperature, the cast film is annealed so as to shrink the cast film simultaneously both in the vertical direction and in the horizontal direction. In this embodiment, the predetermined annealing temperature is ranged between 80° C. and 200° C., and an annealing wind speed is ranged between 5 m/s and 22 m/s. Namely, in this annealing process, a 80° C.˜200° C. hot wind with a 5 m/s˜22 m/s annealing wind speed is provided to the cast film. Also, in the annealing process, a shrinkage ratio of the cast film in either the vertical direction (i.e. the MD direction) or the horizontal direction (i.e. the TD direction) is ranged between 0% and 18%. Preferably, the predetermined annealing temperature is ranged between 120° C. and 150° C.

Step 35: Perform cooling. In a cooling process, at a predetermined cooling temperature, the cast film is cooled down, and then an output retardation film is outputted (Step 36). In this embodiment, the predetermined cooling temperature is ranged between 25° C. and 120° C., and a cooling wind speed is ranged between 5 m/s and 16 m/s. Namely, in this cooling process, a 25° C.˜120° C. hot wind with a 5 m/s˜16 m/s cooling wind speed is provided to the cast film. Preferably, the predetermined cooling temperature is ranged between 25° C. and 100° C.

In the present invention, through the aforesaid specific temperature and wind speed ranges for performing the preheating, the dual-axial stretching, the annealing and the cooling, the output retardation film would have an in-plane retardation value R0 within 0˜3 nm and an in-depth retardation value Rth within −40˜0 nm. A refractive index Nx of the cast film in an in-plane slow axis direction is within 1.499900˜1.499995, a refractive index Ny of the cast film in an in-plane fast axis direction is within 1.499900˜1.499955, a refractive index Nz of the cast film in a thickness direction is within 1.500001˜1.500045, and a thickness of the output retardation film is within 38 μm˜250 μm. Also, the output retardation film is featured in substantial high wider optical uniformity. Such an optical characteristic for the retardation film can meet client's need to some extent for the LCD or OLED display panels. More importantly, by using the aforesaid method, a copolymerizing process is no more needed, and thus the manufacturing of the retardation film is comparatively less complicated and less expensive.

In the preferred embodiment of the method for manufacturing a retardation film by using a dual-axial stretching process in accordance with the present invention, except for the aforesaid specific limitations of temperatures and wind speeds in the preheating, the dual-axial stretching, the annealing and the cooling, the predetermined stretching temperature (Text), the MD value, the TD value and the predetermined annealing temperature (Tshrink) shall fulfill the following mathematical criteria.

R0=α*ΔTe+β*ΔXe+γ*ΔTs+δ*ΔXs+C1;

wherein,

R0 is the in-plane retardation value of the output retardation film, and R0 is within 0˜3 nm;

ΔTe is the temperature difference value in the stretching process, and ΔTe=Text−Tg;

ΔXe is the stretching magnification factor difference value in the stretching process, and ΔXe=MD−TD;

ΔTs is the temperature difference value in the annealing process, and ΔTs=Tshrink−Tg;

ΔXs is the shrinkage ratio value of the cast film in the annealing process; and,

ΔXs=[(1−MDshrink)*(1−TDshrink)−1], in which the MDshrink is the shrinkage ratio of the cast film in the vertical direction in the annealing process, and TDshrink is the shrinkage ratio of the cast film in the horizontal direction in the annealing process.

Also, α, β, γ, δ and C1 are all machine parameters, Tg is the material parameter. Based on different processing machines or different raw materials, the corresponding parameter values would be different. In this embodiment, α=−0.0879, β=−6.24, γ=0.011, δ=−12.8, Tg=118 and C1=2.19.

Preferably, the predetermined stretching temperature (Text), the MD value, the TD value, and the predetermined annealing temperature (Tshrink) shall fulfill further the following mathematical criteria.

Rth=a*ΔTe+b*ΔXe+c*ΔTs+d*ΔXs+C2;

wherein,

Rth is the in-depth retardation value of the output retardation film, and Rth value is within −40˜0 nm;

ΔTe is the temperature difference value in the stretching process, and ΔTe=Text−Tg;

ΔXe is the difference value of the stretching magnification factor in the stretching process, and ΔXe=MD−TD;

ΔTs is the temperature difference value in the annealing process, and Ts=Tshrink−Tg;

ΔXs is the shrinkage ratio value of the cast film in the annealing process; and,

ΔXs=[(1−MDshrink)*(1−TDshrink)−1], in which the MDshrink is the shrinkage ratio of the cast film in the vertical direction in the annealing process, and TDshrink is the shrinkage ratio of the cast film in the horizontal direction in the annealing process.

Also, a, b, c, d and C2 are all machine parameters, Tg is the material parameter. Based on different processing machines or different raw materials, the corresponding parameter values would be different. In this embodiment, a=0.958, b=2.5, c=0.321, d=12.1, Tg=118 and C2=−39.4.

As shown in FIG. 2, a preferred embodiment of a die casting machine applicable to the method for manufacturing a retardation film by using a dual-axial stretching process is schematically shown. To provide the cast film for undergoing the simultaneous dual-axial stretching process, a thermocompressor 16 (or said as an Adaptor) is applied to melt, mix and extrude the raw granular PMMA resin material into a T-shape mould 11 (T-die) at a temperature within 220° C.˜270° C. The molten raw material inside the T-shape mould 11 is then discharged continuously through a discharge opening 17 (Lip) to coat onto a rolling chill roller 12 at a rotational speed within 2˜10 m/min (preferably 5 m/min). In this embodiment, the temperature around the discharge opening 17 is about a temperature between 200° C. and 250° C. Simultaneously, an electric field system 14 (Pinning wire) is introduced to apply an electric field for adhering the outputted raw material onto the chill roller 12 so as to cool and thus form a film. The film is then fed through and roll-depressed simultaneously between the chill roller 12 and a take-off roller 15 operated at a rotational speed within 2˜6.5 m/min (preferably 4˜6 m/min). The depressed film separated from the chill roller 12 is the aforesaid cast film 13 of the present invention, preferably to have a thickness within 250˜1200 μm and a width within 500˜980 μm, and continuously stretched in the longitudinal direction. In this embodiment, the raw resin material is mainly formed by the PMMA (code T11). A main layer structure is made of the T11 by adding an AS04-5 antistatic agent, while a surface layer structure is also made of the T11 but by adding an MB30-1 anti-adhesive agent. Further, the rotational speed difference between the chill roller 12 and the take-off roller 15 is controlled to be within ±1 m/min. Also, the optical axis and the retardation value are minor factors, and thus the optical characteristics of the cast film 13 can be controlled effectively.

As shown in FIG. 2, the cast film 13 that is outputted from the die casting machine and continuously stretched in the longitudinal direction is then fed to the simultaneous dual-axial stretching machine (FIG. 3) to undergo the processes of the aforesaid Step 32 to Step 36. In each section of the stretching machine, the temperature and the wind speed (regulated by a fan) can be individually adjusted. As shown in FIG. 3, clamped and guided by a track 2a of the stretching machine, the cast film would undergo the preheating process of the aforesaid Step 32 in a preheating section 2b of the stretching machine. In this preheating section 2b, no stretching is applied to the cast film in both the width direction (i.e. the horizontal or TD direction) and the longitudinal direction (i.e. the vertical or MD direction). In practice, at this stage, a hot wind with a preheating wind speed within 5˜22 m/s and a temperature within 120˜200° C. blows the cast film so as to increase the temperature of the cast film to a degree helpful for performing the following stretching process. Then, in a stretching section 2c of the stretching machine, except for a hot wind with a heating wind speed within 5˜16 m/s and a temperature within 120˜200° C. is continuously provided, the track 2a of the stretching machine would perform stretching upon the cast film simultaneously in both the vertical direction (MD direction) and the horizontal direction (TD direction). In this stretching process at the stretching section 2c, any of the vertical stretching magnification factor (MD) and the horizontal stretching magnification factor (TD) of the cast film is ranged from 1.0 to 5.0 times. Then, in an annealing section 2d of the stretching machine, a hot wind with an annealing wind speed within 5˜22 m/s and a temperature within 80˜200° C. is provided to the cast film so as to have the cast film to undergo the annealing process. Simultaneously, appropriate shrinking upon the cast film in both the vertical direction (MD direction) and the horizontal direction (TD direction) is also performed by the track 2a of the stretching machine, and shrinkage ratios of the cast film in both the vertical direction (MD direction) and the horizontal direction (TD direction) are within 0˜18%. Thereafter, in a cooling section 2e of the stretching machine, a hot wind with a cooling wind speed within 5˜16 m/s and a temperature within 25˜120° C. is introduced to blow the cast film so as to have the cast film to undergo the cooling process. After experiencing the cooling process, the cast film is outputted as the output retardation film.

As follows, based on the aforesaid method for manufacturing the retardation film by using the dual-axial stretching process of the present invention, various exemplary embodiments with different testing conditions are provided to verify the aforesaid manufacturing parameters and the mathematical criteria. It would be confirmed from the testing results that the method for manufacturing the retardation film by using the dual-axial stretching process of the present invention can produce a satisfied retardation film for the LCD or OLED display panel that meets the demanded optical characteristics, and no synthesis of copolymers is required.

Firstly, for being applied to the method of FIG. 1 and the machine of FIG. 2, ingredients of the raw resin material for Embodiments 1˜5 are listed in the following Table 1.

TABLE 1
Proportions of ingredients of the raw resin
material for producing the cast film

| | Main layer structure (main) | | | | | Surface layer structure (co) | | | | |
|---|---|---|---|---|---|---|---|---|---|---|
| Raw material | main1 | % | main2 | % | Temperature | co1 | % | co2 | % | Temperature |
| Embodiments | T11 | 95 | AS04-5 | 5 | 270 | T11 | 75 | MB30-1 | 25 | 270 |
| 1~5 | | | | | | | | | | |

Then, according to Table 2, by varying the rotational speed of the take-off roller for different embodiments 1˜5 (i.e. changing the speed difference between the chill roller and the take-off roller), testing results of the optical axis value and the average retardation value of the cast film are shown in the following Table 2. It is found, from Table 2, that optical characteristics of Embodiments 1˜4 are satisfied, but only the R0 value of Embodiment 5 is less satisfied. It is thus concluded that, by controlling the difference of the rotational speeds of the chill roller and the take-off roller to be within ±1 m/min with the rotational speed of the take-off roller within 4˜6 m/min, the optical axis and the retardation value are not affected, and the optical characteristics of the cast film can be effectively controlled.

TABLE 2
Optical characteristics with respect to rotational
speeds of the chill roller and the take-off roller

| | Speed | Speed of | | | | | | Averaged | |
|---|---|---|---|---|---|---|---|---|---|
| Cast film | of chill | take-off | | | | | | retardation | |
| testing | roller | roller | Width | Thickness | Optical axis | | | value | |
| conditions | m/min | m/min | mm | μm | Nx | Ny | Nz | R0 | Rth |
| Embodiment 1 | 5 | 6 | 967 | 537 | 1.499978 | 1.499977 | 1.500045 | 0.437 | −36.83 |
| Embodiment 2 | 5 | 4 | 967 | 537 | 1.499978 | 1.499977 | 1.500045 | 0.421 | −36.4 |
| Embodiment 3 | 5 | 4.5 | 967 | 522 | 1.499978 | 1.499977 | 1.500045 | 0.4 | −36.13 |
| Embodiment 4 | 5 | 5 | 966 | 535 | 1.499978 | 1.499977 | 1.500044 | 0.402 | −35.07 |
| Embodiment 5 | 5 | 6.5 | 966 | 535 | 1.499943 | 1.499962 | 1.500095 | 1.335 | −38.07 |

Then, by having the cast film of Embodiment 4 in Table 2 as a basic example, in the process of manufacture the retardation film by the dual-axial stretching process, by varying and controlling the stretching temperature (ST), the proceeding-directional magnification factor MD, the width-directional magnification factor TD, the anneal temperature (AT), the stretching wind speed (SWS), the annealing wind speed (AWS), the proceeding-directional shrinking percentage (PDSP) and the width-directional shrinking percentage (WDSP) so as to obtain different Embodiments 6˜15 from Embodiment 4 of Table 2, the testing results of the retardation values (R0 and Rth) of the output retardation films of Embodiments 6˜15 (Em 6˜15)are listed in the following Table 3.

TABLE 3
Effect of parameter conditions upon the
retardation values of the output retardation films in the simultaneous
dual-axial stretching process (Gross table)

| | | | | | | | | | | Retardation | |
|---|---|---|---|---|---|---|---|---|---|---|---|
| | | | | | | | | | | values | |
| | ST | MD | TD | SWP | AT | PDSP | WDSP | AWS | Thickness | R0 | Rth |
| | Number Unit | | | | | | | | | | |
| | ° C. | % | % | m/s | ° C. | % | % | m/s | μm | nm | nm |
| Em 6 | 132 | 350 | 320 | 15 | 140 | 9 | 9 | 20 | 81 | 1.52 | −20.26 |
| Em 7 | 132 | 320 | 300 | 15 | 150 | 4.5 | 6 | 20 | 80 | 1.37 | −16.45 |
| Em 8 | 132 | 270 | 250 | 15 | 130 | 6 | 6 | 20 | 82 | 1.21 | −22.93 |
| Em 9 | 143 | 260 | 250 | 15 | 130 | 6 | 6 | 20 | 79 | 0.99 | −14.76 |
| Em 10 | 147 | 260 | 250 | 15 | 130 | 6 | 6 | 20 | 81 | 0.64 | −8.92 |
| Em 11 | 138 | 260 | 250 | 15 | 120 | 6 | 6 | 20 | 78 | 1.32 | −20.75 |
| Em 12 | 143 | 260 | 250 | 15 | 120 | 6 | 6 | 20 | 80 | 0.88 | −15.96 |
| Em 13 | 147 | 260 | 250 | 15 | 120 | 6 | 6 | 20 | 79 | 0.53 | −12.13 |
| Em 14 | 147 | 260 | 250 | 15 | 125 | 18 | 6 | 20 | 79 | 2.03 | −11.89 |
| Em 15 | 147 | 270 | 230 | 15 | 125 | 16 | 13 | 20 | 78 | 0.67 | −11.62 |

Since parameter conditions of Table 3 include changes in the stretching temperature ST, the proceeding-directional magnification factor MD, the width-directional magnification factor TD, the stretching temperature ST, the anneal temperature AT, the proceeding-directional shrinking percentage PDSP, and the width-directional shrinking percentage WDSP, the effect of the individual parameter condition upon the retardation values of the output retardation film is not so easy to observe. Alternatively, it could be easier to observe the effect of the individual parameter condition upon the retardation values of the output retardation film by adopting some specific parameters, namely observing a simplified table from these adopted parameters. For example, if the columns for the adopted parameters include only the number, the stretching temperature, the stretching wind speed, the thickness and the retardation values, then the results are shown in Table 4. It is easy to find, from Table 4, that contributions of the retardation values R0 and Rth of the output retardation film can fulfill the following mathematical expressions:

R0=αΔTstretching temperature, and

Rth=aΔTstretching temperature.

Namely, R0=α(Stretching temperature−Tg), in which Tg=118 and α=−0.0879. Also, Rth=a(Stretching temperature−Tg), in which Tg=118 and a=0.958. In the present invention, the Tg value (material parameter) of the machine parameters is a variable dependent upon the raw material of the cast film, not upon the processing machine. For example, in the case of the code-T11 PMMA, the Tg value (material parameter) of the machine parameters is a constant, i.e. 118 as listed above.

TABLE 4
Contribution of the stretching temperature upon the
retardation values of the output retardation film in
the simultaneous dual-axial stretching process

| | | Stretching | | Retardation | |
|---|---|---|---|---|---|
| | Stretching | wind | | (Contribution | |
| | temperature | speed | | value) | |
| | (ST) | (SWS) | Thickness | R0 | Rth |
| | Unit | | | | |
| Number | ° C. | m/s | μm | nm | nm |
| Em 6 | 132 | 15 | 81 | −1.23 | 13.412 |
| Em 7 | 132 | 15 | 80 | −1.23 | 13.412 |
| Em 8 | 132 | 15 | 82 | −1.23 | 13.412 |
| Em 9 | 143 | 15 | 79 | −2.2 | 23.95 |
| Em 10 | 147 | 15 | 81 | −2.55 | 27.782 |
| Em 11 | 138 | 15 | 78 | −1.76 | 19.16 |
| Em 12 | 143 | 15 | 80 | −2.2 | 23.95 |
| Em 13 | 147 | 15 | 79 | −2.55 | 27.782 |
| Em 14 | 147 | 15 | 79 | −2.55 | 27.782 |
| Em 15 | 147 | 15 | 78 | −2.55 | 27.782 |

In addition, it only the number, the proceeding-directional magnification factor, the width-directional magnification factor, the thickness and the retardation are adopted, the results are listed as Table 5. It is easily found, from Table 5, that contributions of the retardation values R0 and Rth of the output retardation film fulfill the following mathematical expressions, respectively.

R0=βΔXstretching magnification factor, and Rth=bΔXstretching magnification factor.

Namely, R0=β(MDmagnification factor−TDmagnification factor), where β=−6.24. Rth=+b(MDmagnification factor−TDmagnification factor))−1], where b=2.5.

TABLE 5
Contributions of the stretching magnification factor
upon the retardation values of the output retardation
film in the simultaneous dual-axial stretching process

| | Proceeding- | | | | |
|---|---|---|---|---|---|
| | directional | Width- | | Retardation | |
| | magnification | directional | | (contribution | |
| | factor | magnification | | values) | |
| | (MD) | factor (TD) | Thickness | R0 | Rth |
| | Unit | | | | |
| Number | % | % | μm | nm | nm |
| Em 6 | 3.5 | 3.2 | 81 | −1.87 | 0.75 |
| Em 7 | 3.2 | 3 | 80 | −1.25 | 0.5 |
| Em 8 | 2.7 | 2.5 | 82 | −1.25 | 0.5 |
| Em 9 | 2.6 | 2.5 | 79 | −0.62 | 0.25 |
| Em 10 | 2.6 | 2.5 | 81 | −0.62 | 0.25 |
| Em 11 | 2.6 | 2.5 | 78 | −0.62 | 0.25 |
| Em 12 | 2.6 | 2.5 | 80 | −0.62 | 0.25 |
| Em 13 | 2.6 | 2.5 | 79 | −0.62 | 0.25 |
| Em 14 | 2.6 | 2.5 | 79 | −0.62 | 0.25 |
| Em 15 | 2.7 | 2.3 | 78 | −2.5 | 1 |

Further, if only the number, the annealing temperature, the annealing wind speed, the thickness and the retardation are adopted, the results are listed as Table 6. It is easily found, from Table 6, that contributions of the retardation values R0 and Rth of the output retardation film fulfill the following mathematical expressions, respectively.

R0=γΔTannealing temperature, and Rth=cΔTannealing temperature.

Namely, R0=γ(Annealing temperature−Tg), where γ=0.011. Rth=c(Anneal temperature−Tg), where c=0.321.

TABLE 6
Contributions of the annealing temperature upon the
retardation values of the output retardation film in
the simultaneous dual-axial stretching process

| | | | | Retardation | |
|---|---|---|---|---|---|
| | Annealing | Annealing | | (contribution | |
| | temperature | wind speed | | values) | |
| | (AT) | (AWS) | Thickness | R0 | Rth |
| | Unit | | | | |
| Number | ° C. | m/s | μm | nm | nm |
| Em 6 | 140 | 20 | 81 | 0.242 | 7.062 |
| Em 7 | 150 | 20 | 80 | 0.352 | 10.272 |
| Em 8 | 130 | 20 | 82 | 0.132 | 3.852 |
| Em 9 | 130 | 20 | 79 | 0.132 | 3.852 |
| Em 10 | 130 | 20 | 81 | 0.132 | 3.852 |
| Em 11 | 120 | 20 | 78 | 0.022 | 0.642 |
| Em 12 | 120 | 20 | 80 | 0.022 | 0.642 |
| Em 13 | 120 | 20 | 79 | 0.022 | 0.642 |
| Em 14 | 125 | 20 | 79 | 0.077 | 2.247 |
| Em 15 | 125 | 20 | 78 | 0.077 | 2.247 |

Furthermore, if only the number, the proceeding-directional shrinking percentage, the width-directional shrinking percentage, the thickness and the retardation are adopted, the results are listed as Table 7. It is easily found, from Table 7, that contributions of the retardation values R0 and Rth of the output retardation film fulfill the following mathematical expressions, respectively.

R0=δ ΔXshrinking percentage, and Rth=dΔXshrinking percentage.

Namely, R0=δ [(1−MDshrinking percentage)*(1−TDshrinking percentage)−1], where δ=−12.8. Rth=d [(1−MDshrinking percentage)*(1−TDshrinking percentage)−1], where d=12.1.

TABLE 7
Contributions of the shrinking percentage upon the
retardation values of the output retardation film in
the simultaneous dual-axial stretching process

| | Proceeding- | Width- | | | |
|---|---|---|---|---|---|
| | directional | directional | | Retardation | |
| | shrinking | shrinking | | (contribution | |
| | percentage | percentage | | values) | |
| | (PDSP) | (WDSP) | Thickness | R0 | Rth |
| | Unit | | | | |
| Number | % | % | μm | nm | nm |
| Em 6 | 9% | 9% | 81 | 2.2 | −2.08 |
| Em 7 | 4.50% | 6% | 80 | 1.309 | −1.2378 |
| Em 8 | 5% | 6% | 82 | 1.37 | −1.2947 |
| Em 9 | 6% | 6% | 79 | 1.49 | −1.4084 |
| Em 10 | 6% | 6% | 81 | 1.49 | −1.4084 |
| Em 11 | 6% | 6% | 78 | 1.49 | −1.4084 |
| Em 12 | 6% | 6% | 80 | 1.49 | −1.4084 |
| Em 13 | 6% | 6% | 79 | 1.49 | −1.4084 |
| Em 14 | 18% | 6% | 79 | 2.934 | −2.7733 |
| Em 15 | 16% | 13% | 78 | 3.446 | −3.2573 |

Accordingly, after each verification of the foregoing mathematical criteria by the results listed from Table 4 through Table 7, two aforesaid mathematical criteria of the present invention can be then obtained. In particular, by plugging data of Table 3, these two mathematical criteria of the present invention, as follows, are still fulfilled.

R0=α*ΔTe+β*ΔXe+γ*ΔTs+δ*ΔXs+C1, and

Rth=a*ΔTe+b*ΔXe+c*ΔTs+d*ΔXs+C2.

Since these two mathematical criteria have been fully disclosed above, thus details thereabout are omitted herein. If the method of the present invention is applied to other machine, different embodiments having different given parameter conditions (i.e. via controlling and varying the stretching temperature, the proceeding-directional magnification factor MD, the width-directional magnification factor TD, the annealing temperature, the proceeding-directional shrinking percentage, the width-directional shrinking percentage and so on) can be provided in a manner similar to the aforesaid Table 3. Then, retardation values R0 and Rth of the output retardation films produced from the respective embodiments are measured to generate the parameters to be plugged into these two mathematical criteria. Thereupon, machine parameters such as α, β, γ, δ, C1, a, b, c, d and C2 can be calculated. Thereafter, according to these two mathematical criteria and the calculated machine parameters, optimal stretching temperature, proceeding-directional magnification factor MD, width-directional magnification factor TD, annealing temperature, proceeding-directional shrinking percentage, width-directional shrinking percentage and the other parameter can then be achieved so as to meet the industrial requirements upon specific optical characteristics of the retardation film. Therefore, according to steps shown in FIG. 1 by accompanying specific temperature, wind speed, stretching magnification factor, shrinkage ratio and any other parameter condition and also by using the aforesaid two mathematical criteria, an optical-qualified retardation film made of the raw PMMA material for the LCD or OLED display panel can thus be produced without any synthesis of copolymers. Apparently, the object of the present invention can be successfully achieved by applying the method for manufacturing a retardation film by using a dual-axial stretching process as described above.

While the present invention has been particularly shown and described with reference to a preferred embodiment, it will be understood by those skilled in the art that various changes in form and detail may be without departing from the spirit and scope of the present invention.

What is claimed is:

1. A method for manufacturing a retardation film by using a dual-axial stretching process, comprising the steps of:
Step (A): providing a cast film;
Step (B): in a preheating process, at a predetermined preheating temperature, preheating the cast film;
Step (C): in a stretching process, at a predetermined stretching temperature, performing simultaneously dual-axial stretching upon the cast film; wherein, in this stretching process, the cast film is stretched by a vertical stretching magnification factor (MD) and a horizontal stretching magnification factor (TD), and both the MD and the TD are within 1.0˜5.0 times;
Step (D): in an annealing process, at a predetermined annealing temperature, annealing the cast film so as to shrink the cast film simultaneously in both a vertical direction and a horizontal direction; and
Step (E): in a cooling process, at a predetermined cooling temperature, cooling the cast film, and then outputting an output retardation film.

2. The method for manufacturing a retardation film of claim 1, wherein:
the predetermined preheating temperature is within 100˜200° C., and, while in preheating, a preheating wind speed is within 5˜22 m/s;
the predetermined stretching temperature is within 120˜200° C., and, while in stretching, a stretching wind speed is within 5˜16 m/s so as to control a temperature of the cast film in the stretching process to be within 120˜170° C.;
the predetermined annealing temperature is within 80˜200° C., and, while in annealing, a annealing wind speed is within 5˜22 m/s;
the predetermined cooling temperature is within 25˜120° C., and, while in cooling, a cooling wind speed is within 5˜16 m/s; and,
in the annealing process, a shrinkage ratio for both the MD and the TD of the cast film is within 0˜18%.

3. The method for manufacturing a retardation film of claim 1, wherein the predetermined stretching temperature (Text), the MD, the TD and the predetermined annealing temperature (Tshrink) fulfill mathematical criteria as follows:
R0=α*ΔTe+β*ΔXe+γ*ΔTs+δ*ΔXs+C1;
wherein:
R0 is an in-plane retardation value of the output retardation film and is within 0˜3 nm;
ΔTe is a temperature difference value in the stretching process, and ΔTe=Text−Tg;
ΔXe is a stretching magnification factor difference value in the stretching process, and ΔXe=MD−TD;
ΔTs is a temperature difference value in the annealing process, and ΔTs=Tshrink−Tg;
ΔXs is a shrinkage ratio value of the cast film in the annealing process, and ΔXs=[(1−MDshrink)*(1−TDshrink)−1], wherein the MDshrink is a shrinkage ration of the cast film in the vertical direction in the annealing process, wherein the TDshrink is a shrinkage ration of the cast film in the horizontal direction in the annealing process; and
α, β, γ, δ and C1 are all machine parameters, and Tg is a material parameter.

4. The method for manufacturing a retardation film of claim 3, wherein α=−0.0879, β=−6.24, γ=0.011, δ=−12.8, Tg=118 and C1=2.19.

5. The method for manufacturing a retardation film of claim 1, wherein the predetermined stretching temperature (Text), the MD, the TD, and the predetermined annealing temperature (Tshrink) fulfill mathematical criteria as follows:
Rth=a*ΔTe+b*ΔXe+c*ΔTs+d*ΔXs+C2;
wherein:
Rth is an in-depth retardation value of the output retardation film and is within −40˜0 nm;
ΔTe is a temperature difference value in the stretching process, and ΔTe=Text−Tg;
ΔXe is a stretching magnification factor difference value in the stretching process, and ΔXe=MD−TD;
ΔTs is a temperature difference value in the annealing process, and ΔTs=Tshrink−Tg;
ΔXs is a shrinkage ratio value of the cast film in the annealing process, and ΔXs=[(1−MDshrink)*(1−TDshrink)−1], wherein the MDshrink is a shrinkage ration of the cast film in the vertical direction in the annealing process, wherein the TDshrink is a shrinkage ration of the cast film in the horizontal direction in the annealing process; and
a, b, c, d and C2 are all machine parameters, and Tg is a material parameter.

6. The method for manufacturing a retardation film of claim 5, wherein a=0.958, b=2.5, c=0.321, d=12.1, Tg=118 and C2=−39.4.

7. The method for manufacturing a retardation film of claim 2, wherein:
the predetermined preheating temperature is within 145˜155° C.;
the predetermined stretching temperature is within 130˜150° C.;
the predetermined annealing temperature is within 120˜150° C.; and
the predetermined cooling temperature is within 25˜100° C.

8. The method for manufacturing a retardation film of claim 1, wherein the cast film is made of a PMMA having a thickness within 250˜1200 μm and a width within 500˜980 μm.

9. The method for manufacturing a retardation film of claim 1, wherein an in-plane retardation value R0 of the output retardation film is within 0˜3 nm, an in-depth retardation value Rth of the output retardation film is within −40˜0 nm, a refractive index Nx of the cast film in an in-plane slow axis direction is within 1.499900˜1.499995, a refractive index Ny of the cast film in an in-plane fast axis direction is within 1.499900˜1.499955, a refractive index Nz of the cast film in a thickness direction is within 1.500001˜1.500045, and a thickness of the output retardation film is within 38˜250 μm.

10. A retardation film manufactured by the method of claim 1, wherein an in-plane retardation value R0 of the output retardation film is within 0˜3 nm, an in-depth retardation value Rth of the output retardation film is within −40˜0 nm, a refractive index Nx of the cast film in an in-plane slow axis direction is within 1.499900˜1.499995, a refractive index Ny of the cast film in an in-plane fast axis direction is within 1.499900˜1.499955, a refractive index Nz of the cast film in a thickness direction is within 1.500001˜1.500045, and a thickness of the output retardation film is within 38˜250 μm.
